(19) United States
(12) Patent Application Publication
(10) Pub. No.: US 2007/0116283 A1
(43) Pub. Date: May 24, 2007

(54) Method and device for efficient multiparty multiplication

(75) Inventors: Pim Theo Tuyls, Eindhoven (NL); Berry Schoenmakers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/577,757

(22) PCT Filed: Nov. 2, 2004
(86) PCT No.: PCT/IB04/52259

§ 371 Date: Apr. 28, 2006

(30) Foreign Application Priority Data
Nov. 3, 2003 (EP) 03078437.5

(51) Int. Cl. H04K 1/00

(52) U.S. Cl. 380/255

(57) ABSTRACT

The invention introduces, in the framework of secure multiparty computation based on homomorphic threshold cryptosystems, a protocol and a special type of multiplication gate that can be realized in a surprisingly simple and efficient way using just standard homomorphic threshold ElGamal encryption. As addition gates are essentially for free, the conditional gate not only allows for building a circuit for any function, but actually yields efficient circuits for a wide range of tasks.

The invention relates to a method for a party participating in a secure multiparty multiplication protocol between participants, a device being arranged for implementing this method, and a computer program product having computer executable instructions for causing a programmable device to perform this method.

Secure multiparty computation is the process where a number of participants compute a function ƒ to obtain an unencrypted output. During the computation, only the output becomes available to the participants.

Some well known examples of these kind of computations are auctions, the Millionaires problem, secure function evaluation, voting, crypto computing with rational and secure profile matching.

Homomorphic threshold cryptosystems provide a basis for secure multiparty computation. For a given n-ary function ƒ a circuit of elementary gates is composed that, given encryptions of x₁, . . . , xₙ on its input wires, produces an encryption of ƒ(x₁, . . . , xₙ) on its output wire. The elementary gates operate in the same fashion. The wires of the entire circuit are all encrypted under the same public key; the corresponding private key is shared among a group of parties.

The elementary gates operate on bits or on elements of larger domains (rings or fields), where apparently the latter type is preferred from an efficiency point of view.

A basic tool in the toolbox for computing under the encryption, is a secure multiplication protocol. And although addition gates can be evaluated without having to decrypt any value, taking full advantage of the homomorphic property of the cryptosystem, multiplication gates, however, requires at least one threshold decryption to succeed.

In U.S. Pat. No. 6,772,339, a method is described for secure multiparty computation comprising: generating a data set based on a function to be computed, said data set comprising pairs of first data and second data; for each pair of first data and second data, encrypting said first data and said second data; mixing pairs of encrypted first data and second data; comparing encrypted input data with said encrypted input data to detect a match; and selecting encrypted second data corresponding to said detected match.

The resulting protocol for evaluating multiplication gates is, despite its conceptual simplicity, quite inefficient.

It is therefore an object of the invention to provide a method and a device that provide an efficient building block for multiparty computations, in particular for the multiplication protocol.

The object of the invention is achieved by a method for a party participating in a secure multiparty multiplication protocol between participants, the protocol being arranged to compute the product of private first data and encrypted second data, wherein the protocol comprises a subprotocol comprising the steps of -the party obtaining first data), which is either -private first data or -first data from a two-valued domain, -the party obtaining encrypted second data, -the party computing encrypted output data which comprises a randomized encryption of the product of the first data and, the second data, using a discrete log based cryptosystem, and -the party generating a proof being arranged to show that the encrypted output data is correct.

A multiplication protocol takes as input a private or encrypted multiplier x and an encrypted multiplicand y and produces in polynomial time as output an encryption of the product xy. The protocol should not leak any information on x, y, and xy. Furthermore, for security reasons it is required that the protocol generates a publicly verifiable proof that the product is computed directly.

According to the method according to the invention, and given private or encrypted first data [[x]]=(a, b)=(g^{r}, g^{x}h^{r}) and encrypted second data [[y]]=(c, d), where party P knows r, x, party P computes a randomized encryption [[xy]]=(e, f)=(g^{s}, h^{s})* [[y]]^{x}, with sε_{R}Z_{q}, using the homomorphic properties of the discrete log based cryptosystem. The Party P also generates a proof showing that the output is correct, which means that it proves knowledge of witnesses r; s; xεZ_{q} satisfying a=g^{r}, b=g^{x}h^{r}, e=g^{s}c^{x}, ƒ=h^{s}d^{x}.

The method allows to implement applications efficiently, for example the method allows at least two users to compare their private data without revealing any other information than whether they are similar or not, according to some measure.

It is a further advantage of such a discrete log based solution that distributed key generation for the threshold version is relatively simple.

It is an additional advantage that the method also addresses treating the malicious case and addresses fairness for the two-party case.

It is a further advantage that the invention performs particularly well for ad hoc contacts among a large group of peer users, where it is important that each user needs only a limited amount of set-up information (independent of the total number of users), and the total time of execution—including the time for distributed key generation—for running a protocol between any two users is limited as well.

The method of the multiplication protocol requires that one of the multipliers is private, that is, known by a single party.

This restriction allows the multiplication protocol to exist under the Diffie-Hellman assumption.

An advantageous method according to the invention is characterized in that the first data is random data from a two-valued domain.

The method allows at least two users to obtain the product of two numbers, one of which is a random number from a two-valued domain, and a proof that the result was correctly computed.

The method implements a protocol which enables to compute the encrypted product of two encrypted numbers.

In the protocol according to claim 2, which is referred to as the conditional gate, the multiplier x is from a dichotomous (two-valued) domain. This restriction allows the multiplication protocol to exist under the Diffie-Hellman assumption. It is realized by the inventors that elementary gates operating on bits are sufficient for efficiently implementing multiparty computations including multiplication.

The protocol according to claim 2 is able to efficiently multiply the encrypted values x and y, if x is restricted to a two-valued domain.

An advantageous method according to the invention is characterized in that the discrete log based cryptosystem is the ElGamal cryptosystem.

It is understood by the inventors that basically homomorphic ElGamal suffices for efficiently handling a wide range of problems. The encryptions of second data, are homomorphic ElGamal encryptions, where it is understood that these encryptions are randomized and the public key for these encryptions is always the same. The corresponding private key is shared among a number of parties.

It is an advantage that the current method works under the standard Decision Diffie-Hellman assumption using just homomorphic threshold ElGamal encryption, which is far less costly than for example the use of RSA-like cryptosystems such as Paillier's cryptosystem, as the generation of a shared RSA modulus for the corresponding threshold cryptosystems is costly, often dominating the cost of an entire application. Even for the two-party case, sharing an RSA modulus is a non-trivial task. In contrast, distributed key generation for discrete log based cryptosystems is simple, and practically for free in the two-party case.

As an additional advantage, ElGamal allows for solutions based on any discrete log setting, such as elliptic curves or XTR.

The work for each party for evaluating a conditional gate amounts to about 12 exponentiations, whereas the Mix and Match approach from the aforementioned US patent requires approximately 150 exponentiations for a similar multiplication gate, as each party needs to blind and permute the 4×3 ElGamal encryptions constituting the encrypted truth table of the gate and provide a proof of correctness; each party must also take part in four plaintext-equality tests, on average.

The method according to the current invention is therefore probably the most efficient solution to date for Yao's millionaires problem and many other problems, such as secure auctions.

An advantageous method according to the invention is characterized in that the encrypted data are Pederson commitments.

Often a slight optimization is possible by using a Pedersen commitment <<x>>=g^{x}h′^{r} instead of an ElGamal encryption [[x]]=(g^{r}, g^{x}h^{r}) for the multiplier.

An advantageous method according to the invention is characterized in that the protocol comprises the further step of -the party transmitting the proof to at least one of the other participants,

An advantageous method according to the invention is characterized in that the protocol comprises the further step of -the party transmitting the encrypted output data to at least one of the other participants,

An advantageous method according to the invention is characterized in that the protocol is executed between two parties.

The object of the invention is further achieved by a device being arranged for implementing the method according to claim 1.

The object of the invention is further achieved by a computer program product, for enabling multiparty computations, having computer executable instructions for causing a programmable device to perform the method according to claim 1.

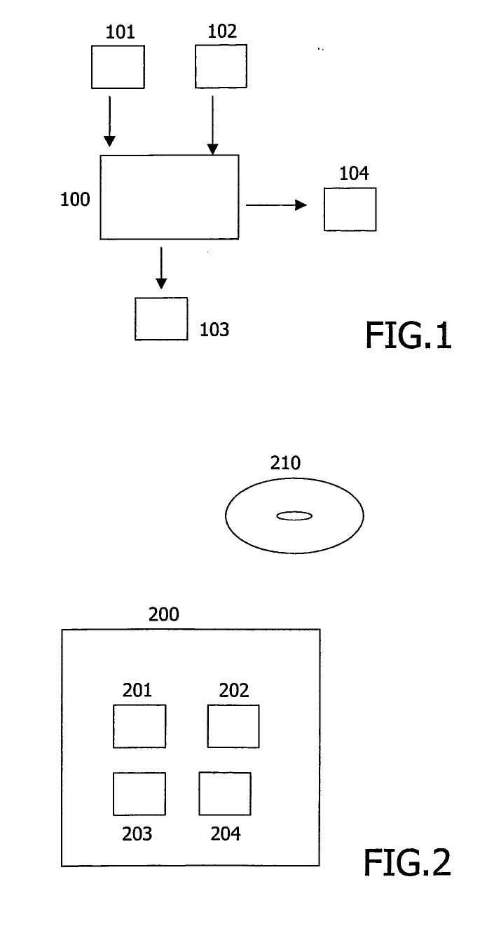

FIG. 1 illustrates a subprotocol of the multiplication protocol, and

FIG. 2 shows a device for implementing the method according to the invention.

A multi-party multiplication protocol is a protocol carried out by two or more participants.

The input of the protocol consists of two (possibly encrypted) numbers, x and y. The number x can be provided by player P₁ and y can be provided by player P₂. At the end of the protocol, both players get the product [[xy]] as a result. Moreover the parties get a proof that the result was correctly computed and that the other player(s) did not cheat.

First some preliminaries for the computations are discussed.

Let G=<g> denote a finite cyclic (multiplicative) group of prime order q for which the Decision Diffie-Hellman (DDH) problem is assumed to be infeasible.

For public key hεG, additively homomorphic ElGamal encryption is used, where message mεZ_{q} is encrypted as a pair (a,b)=(g^{r}, g^{m} h^{r}), with rεZ_{q}. The homomorphic property is that component wise multiplication of encryptions of m and m′, respectively, yields an encryption of m+m′ (modulo q): (a, b)*(a′,b′)=(aa′,bb′)=(g^{r+r′}, g^{m+m′}h^{r+r′}).

Given an encryption (a,b)=(g^{r}, g^{m} h^{r}) as common input, standard techniques yield a proof of knowledge for showing knowledge of the (unique) witness (m,r). (Standard ElGamal encryption with encryptions of the form (g^{r}, m h^{r}) for mεG is homomorphic in a multiplicative sense but lacks such a proof of knowledge.)

An equivalence relation is defined on G×G by stating that encryptions (a, b) and (a′,b′) are equivalent iff log_{g} (a/a′)=logₕ(b/b′). Using (1,g^{m}), mεZ_{q}, as canonical representatives, [[m]] is used to denote the equivalence class of (1,g^{m}). In other words, [[m]] denotes the set of all ElGamal encryptions of m (under public key h). The operations on the direct product group G×G are lifted to the equivalence classes in the usual way. The homomorphic property then implies that [[x]]*[[y]]=[[x+y]] and [[x]]^{c}=[[cx]].

Thus addition and multiplication by a scalar are easily accomplished. These operations can easily be verified when implemented in a deterministic fashion.

Randomization (or blinding) of ElGamal encryptions is an important primitive as well. This amounts to multiplying a given encryption with a random element (a, b) ER [[0]]. Proving that log_{g} a=logₕ b shows that (a, b) is indeed an encryption of 0.

Given the private key α=log_{g} h, decryption is performed by calculating b/a^{α}, which is equal to g^{m} for some mεZ_{q}. Recovering m from g^{m} is supposed to be hard in general, hence it is necessary to view this cryptosystem with respect to a set MεZ_{q} of sufficiently small size such that finding m from g^{m} is feasible whenever mεM. In the current invention, however, the size of M will be very small, often |M|=2.

The ElGamal cryptosystem is semantically secure under the DDH assumption.

In a (t,n)-threshold version of ElGamal, 1≦t≦n, encryptions are computed w.r.t. a common public key h (as above) while decryptions are done using a joint protocol between n parties, each party possessing a share of the private key α=log_{g} h. As long as at least t parties take part, decryption will succeed, whereas fewer than t parties are not able to decrypt successfully. The parties obtain their share by running a distributed key generation protocol.

Since the invention is particularly of interest to two-party computations, more details are presented for the (2,2)-threshold scheme. Distributed key generation is achieved by having parties P₁, P₂ first broadcast commitments cᵢ=g^{α}ᵢh^{r}ᵢ, with aᵢ,rᵢεZ_{q} for i=1,2, and then broadcast the values rᵢ along with proofs of knowledge of log_{g} hᵢ, where hᵢ=cᵢ/h^{r}ᵢ for i=1,2. The joint public key is h=h₁h₂, with private key α=α₁+α₂. To decrypt an encryption (a,b), player Pᵢ produces dᵢ=a^{α}ᵢ, along with a proof that log_{d} dᵢ is equal to log_{g} hᵢ. The message is then recovered from b/(a₁a₂).

Clearly, (2,2)-threshold ElGamal allows for ad-hoc use. The effort for generating the keys is about the same as the effort for performing a decryption.

Given two homomorphic encryptions [[x]],[[y]] the homomorphic encryption [[xy]] can be computed by the protocol comprising the following steps:

Player Pᵢ chooses a random value rᵢ and sends [[rᵢ]] to player P₃₋ᵢ along with a proof that it knows rᵢ, for i=1,2.

The players jointly decrypt [[x+r₁+r₁]].

Let x₁=x+r₂, x₂=−r₂. Player Pᵢ sends [[xᵢ]], [[fᵢ]]=xᵢ[[b]] to player P₃₋ᵢ along with a proof, for i=1,2.

Both players may compute [[f₁]]+[[f₂]]=[[xy]].

If any of the proofs fails, the protocol is aborted.

As a last preliminary, the Pedersen Commitment is shown. Given g,hεG, a commitment to message mεZ_{q} is a value c=g^{m} h^{r}, with rε_{R}Z_{q}. The commitment is opened by revealing m and r. Pedersen's scheme is unconditionally hiding and computationally binding, under the assumption that log_{g} h cannot be determined. The commitment scheme is also additively homomorphic, and <<m>> will be used to denote a commitment to message m, where the randomization is suppressed.

According to these preliminaries, a function f can be evaluated securely in a multiparty setting if ƒ can be represented as a circuit over Z_{q} consisting only of addition gates and simple multiplication gates. An addition gate takes encryptions [[x]] and [[y]] as input and produces [[x]]*[[y]]=[[x+y]] as output, and a simple multiplication gate takes [[x]] as input and produces [[x]]c=[[cx]] as output, for a publicly known value cεZ_{q}. To be able to handle any function f, however, there is a need for more general multiplication gates for which both inputs are encrypted.

If no restrictions are put on x or y, a multiplication gate, taking [[x]] and [[y]] as input and producing [[xy]] as output efficiently, cannot exist assuming that the DH problem is infeasible. Therefore, a special multiplication gates is used, putting some restrictions on the multiplier x.

In a first embodiment of the invention, the method requires that the multiplier x is private, which means that it is known by a single party.

In a second embodiment of the invention, the method comprises the use of a special multiplication gate. This gate, referred to as the conditional gate, requires that the multiplier x is from a dichotomous (two-valued) domain. This protocol will be referred to as a multiplication protocol with a shared dichotomous multiplier. This protocol is less general but far more efficient than the protocols already known.

Despite these restrictions, the method according to the invention leads to very efficient multiparty protocols.

First, in the first embodiment according to the invention, a multiplication protocol is presented where the multiplier x is a private input (rather than a shared input). That is, the value of x is known by a single party P. No restriction is put on the multiplicand y. Multiplication with a private multiplier occurs as a subprotocol in the protocol for the conditional gate, and in a number of separate other protocols.

FIG. 1 illustrates two different embodiments of the invention. Party P, 100, obtains private first data, [[x]], 101, and encrypted second data, [[y]], 102, computes encrypted output data, [[xy]], 103, including a correctness proof 104. Obtaining can be either receiving from a different party, retrieving from internal memory, or generating internally.

Given encryptions [[x]]=(a, b)=(g^{r}, g^{x}h^{r}) and [[y]]=(c, d), where party P knows r, x, party P computes on its own a randomized encryption [[xy]]=(e, f)=(g^{s}, h^{s})*[[y]]^{x}, with sε_{R} Z_{q}, using the homomorphic properties. Party P then broadcasts [[xy]] along with a proof showing that this is the correct output, which means that it proves knowledge of witnesses r; s; xεZ_{q} satisfying a=g^{r}, b=g^{x}h^{r}, e=g^{s}c^{x}, f=h^{s}d^{x}.

For later use, the above protocol needs to be simulated. The simulator gets as input [[x]] and [[y]], and a correct output encryption [[xy]], but it does not know x. As a result, the simulator only needs to add a simulated proof of knowledge. The simulated transcript is statistically indistinguishable from a real transcript.

It is possible to use a variation of the above protocol, where the private multiplier x is multiplied with several multiplicands yᵢ at the same time. Furthermore, a slight optimization is possible by using a Pedersen commitment <<x>>=g^{x}h′^{r} instead of an ElGamal encryption [[x]]=(g^{r}, g^{x}h^{r}) for the multiplier.

In the second embodiment of the invention, the conditional gate is used as a special type of multiplication gate that can be realized in a surprisingly simple and efficient way using just standard homomorphic threshold ElGamal encryption. As addition gates are essentially for free, the conditional gate not only allows for building a circuit for any function, but actually yields efficient circuits for a wide range of tasks.

The dichotomous domain {−1,1} is convenient for explanation purposes. Domain {0,1} or any other domain {a, b}, a≠b, can be used instead, as these domains can be transformed into each other by linear transformations. These transformations can also be applied to encryptions.

The conditional gates will be illustrated along two different protocols.

In the first protocol to implement the conditional gate, the protocol enables players P₁, . . . P_{N}, N≧2, to compute an encryption [[xy]] securely. For simplicity, it is assumed that the players also share the private key of the homomorphic encryption scheme [[.]].

In protocol stage 1: for i=1 . . . N, player Pᵢ takes [[xᵢ₋₁]] as input and chooses sᵢε_{R} {−1,1}. Player Pᵢ broadcasts encryptions [[sᵢ]] and [[sᵢ xᵢ₋₁]], and a proof that [[sᵢ xᵢ₋₁]] is correct w.r.t. [[sᵢ]] and [[xᵢ₋₁]], using the protocol for multiplication with a private multiplier. Let xᵢ=sᵢxᵢ₋₁.

In protocol stage 2: the players jointly decrypt [[x_{N}]] to obtain x_{N}. Each player checks that x_{N}ε{−1,1}. Given x_{N} and [[y]], the encryption [[x_{N} y]] is computed publicly. Let z₀=x_{N} y.

In protocol stage 3: for i=1 . . . N, player Pᵢ takes [[zᵢ₋₁]] as input and broadcasts an encryption [[sᵢ zᵢ₋₁]], and a proof that [[sᵢ zᵢ₋₁]] is correct w.r.t. [[sᵢ]] and [[zᵢ₋₁]], using the protocol for multiplication with a private multiplier. Let zᵢ=sᵢzᵢ₋₁.

The output of the protocol is [[z_{N}]]=[[xy]]. The protocol requires a single threshold decryption only. Since x_{N}ε_{R}{−1,1} must hold, decryption is feasible for the homomorphic ElGamal encryption scheme. The protocol requires roughly 2N rounds.

As the value of x_{N} is statistically independent if at least t=N/2 honest players are able to complete the protocol successfully, the value of x_{N} does not reveal any information on x.

The protocol can optionally be made robust. If a player Pᵢ fails in protocol stage 2, it is simply discarded in the remainder of the protocol. For stage 2, the joint decryption step is robust by definition. If the check x_{N}ε{−1,1} fails, the players are required to broadcast a proof that sᵢε{−1,1}. The players who fail to provide a correct proof are discarded, and their sᵢ values are decrypted. The value of x_{N} is adjusted accordingly. Similarly, in stage 2, if player Pᵢ fails to complete its step, its value sᵢ is decrypted and the encryption [[sᵢ zᵢ₋₁]] is computed publicly.

This protocol is correct, sound, and computational zk.

In the second protocol implementation of the second embodiment, again the dichotomous domain is {−1, 1} used but any different domain could be used instead using a linear mapping.

Let [[x]], [[y]] denote encryptions, with xε{−1,1}⊂Z_{q} and yεZ_{q}. The following protocol enables parties P₁ . . . Pₙ, n>1, to compute an encryption [[xy]] securely. For simplicity, it is assumed that these parties also share the private key of the (t+1; n)−threshold scheme [[.]], where t<n. The protocol consists of two phases.

Protocol phase 1. Let x0=x and y0=y. For i=1 . . . n, party Pᵢ in turn takes [[x_{i-1]] and [[y}ᵢ₋₁]] as input, and broadcasts a commitment <<sᵢ>>, with sᵢε_{R}{31 1,1}. Then Pᵢ applies the private-multiplier multiplication protocol to multiplier <<sᵢ>> and multiplicands [[xᵢ₋₁]] and [[yᵢ₋₁]], yielding random encryptions [[xᵢ]] and [[yᵢ]], where xᵢ=sᵢxᵢ₋₁ and yᵢ=sᵢyᵢ₋₁. If Pᵢ fails to complete this step successfully it is discarded immediately.

Protocol phase 2. The parties jointly decrypt [[xₙ]] to obtain xₙ. If decryption fails because the number of correct shares is insufficient, the entire protocol is aborted. If decryption fails because xₙ∉{−1,1}, each party Pᵢ is required to broadcast a proof that sᵢε{−1,1}. Parties failing to do so are discarded, and the protocol is restarted (starting again at phase 1). Given xₙ and [[yn]], an encryption [[xₙyₙ]] is computed publicly. If all parties are honest, xₙyₙ=xy.

Any party may disrupt the protocol for at most one run of phase 1 by picking a value sᵢ outside the range {−1,1}. For t<n/2, the protocol is robust, allowing up to t failing parties in total (as the threshold decryption step tolerates up to t failing parties). For n/2≦t<n, the protocol is not robust, but the adversary does not get an advantage in this case.

The protocol requires a single threshold decryption only. Since xₙ is two-valued is required to hold, decryption is feasible for the homomorphic ElGamal encryption scheme. As the value of xₙ is statistically independent of x, the value of xₙ, does not reveal any information on x.

If the total number of parties is large compared to the total number of conditional gates to be evaluated, an alternative way to guarantee robustness is to let the parties use encryptions [[sᵢ]] instead of commitments <<sᵢ>> in phase 1. Again, if xₙ∉{−1, 1} in phase 2, all parties are required to prove that sᵢε{−1,1}. Failing parties are discarded and their si values are decrypted to correct the value of xₙ.

The performance of the protocol is determined by the communication complexity (in bits) and the round complexity. In phase 1 each party applies the private-multiplier multiplication protocol, broadcasting about 10 values. For decryption each party broadcasts 3 values at the most. Hence, the communication complexity is O(nk) where the hidden constant is very small. In general, the round complexity is O(n), which is high, but in case of two-party computation it is O(1). Also, when many conditional gates are to be evaluated in parallel, one may take advantage of the fact that the order in which parties P₁ . . . Pₙ execute phase 1 of the conditional gate protocol can be chosen arbitrarily.

As a first application of the conditional gate, xor-homomorphic ElGamal encryption scheme is shown. Given [[x]] and [[y]] with x,yε{0,1}, [[x⊕y]] is computed as follows, using one threshold decryption:

step 1: publicly convert [[x]] to [[x′]] with x′=2x−1ε{−1,1}.

step 2: apply the conditional gate to [[x′]] and [[y]] to obtain [[x′y]].

step 3: publicly compute [[x−x′y]], which is equal to [[x⊕y]].

The application of the conditional gate requires a threshold decryption, which seems unavoidable for achieving xor-homomorphic ElGamal encryption.

The work per party is very limited, about 13 exponentiations for each conditional gate. In contrast, the Mix and Match approach of according to the US patent mentioned would require each party to mix the 4 rows of a truth table for x⊕y in a verifiable way (Mix step, requiring 24 exponentiations for blinding the entries and, say, 6×12 exponentiations for the correctness proof (using the efficient protocol of J. Groth, “A verifiable secret shuffle of homomorphic encryptions, public key cryptography PKC'03, volume 2567 of Lecture Notes in Computer Science, pages 145-160, Berlin, 2003, Springer-Verlag) and perform on average 4 plaintext equality tests to find [[x⊕y]] given [[x]] and [[y]] (Match step, requiring 4×7 exponentiations). Hence, the conditional gate provides approximately a ten-fold improvement, counting exponentiations.

As a second application of the conditional gate, implementation of a logical gate is shown.

Any operator on two bits x and y can be expressed in a unique way as a polynomial of the form: a₀+a₁x+a₂y+a₃xy. The coefficients are not necessarily binary. For example, the exclusive-or operator ⊕ satisfies x⊕y=x+y−2xy. There are exactly 16 polynomials of type {0,1}²→{0,1}, which is immediate if one considers the following normal form: b₀xy+b₁x(1−y)+b₂(1−x)y+b₃(1−x)(1−y), where the coefficients are binary. In general, the coefficients need not be integers either, if one works with other two-valued domains such as {−1,1}.

In the following applications of the conditional gate, the special multiplication gate is applied to obtain efficient circuits for basic operations such as integer comparison and addition of binary represented numbers.

As a third application of the conditional gate, an efficient solution for a slight variant of Yao's millionaires problem is shown that allows extensions to more general situations. In this application, the inputs are given by their binary representations, i.e. x=(xₙ₋₁, . . . , x₀) and y=(yₙ₋₁, . . . , y₀) respectively. A multivariate polynomial P over Z is defined that implements the sign function.

Several polynomials can be used to implement this function. It appears that the most efficient solution can be constructed based on the following multivariate reduction polynomial: for x,yε{0,1}, F(s,x,y)=s+(1−s²)(x−y). The polynomial F can be efficiently evaluated by introducing an auxiliary variable v=1−s². Initially, s=0 and v=1. Then, the computation

s,v=s+v(x−y), v−v(x−y)² is repeated for all components of x and y, giving the desired result. The expression v−v(x−y)² can be computed as v(1−x+2xy−y). In order to do this computation in a private way, three basic steps are required, where a player multiplies its x or y with a given homomorphic encryption.

Player 1 computes [[vx]] from [[v]] and ((x)).

Player 2 computes [[vy]] and [[vxy]] from [[v]] resp. [[vx]] and ((y)).

Both players may compute [[s+vx−vy]] (which is the new s).

Both players may compute [[v−vx+2vxy−vy]] (which is the new v).

If needed, s can be decrypted using threshold decryption. Note that this algorithm needs three “multiplication with a private multiplier” protocols for each bit. The second step in the algorithm can be performed efficiently. This approach can also be applied to the Socialist Millionaires problem to produce the result in encrypted form.

As a fourth application of the conditional gate, addition of two numbers is shown. To add two numbers x,y given by their binary representation, the respective bits are added, also taking the carry into account. To produce the next bit of the output z, it is necessary to compute [[t]]=[[xᵢ+yᵢ+cᵢ₋₁]], where cᵢ₋₁ is the carry value. It holds that zᵢ=t mod 2, and cᵢ=└t/2┘. Computations are zᵢ=xᵢ+yᵢ+cᵢ₋₁−2xᵢyᵢ−2xᵢcᵢ₋₁−2yᵢcᵢ₋₁+4xᵢyᵢcᵢ₋₁ and cᵢ=xᵢyᵢ+xᵢcᵢ₋₁+yᵢcᵢ₋₁−2xᵢyᵢcᵢ₋₁. If both x and y are private, all of these terms can be computed using the “simple” multiplication protocol. 4 such multiplications are needed for each bit. So, O(n) in total, using n rounds. If only one is private, then one dichotomous multiplication is needed. If both are shared, the dichotomous multiplication is used all the time.

Similarly, multiplication of two numbers x,y is achieved by the school method. This requires

O(n²) bit multiplications.

As a fifth application of the conditional gate, computation of the Hamming distance is shown. Given two vectors x and y with entries in Z_{q}, the Hamming distance d_{H}(x,y) between x and y is defined as

$${d}_{H} ( x , y ) = {\sum }_{l = 1}^{n} δ ( {x}_{i} - {y}_{i} ) ,$$

where δ(x)=0 if x=0 and δ(x)=1 if x≠0. The goal of this section, is to compute securely the Hamming distance between x and y without revealing any further information about x and y. More precisely, it is assumed that there are two players P₁ and P₂ each having a vector, say x and y respectively. They want to compute d_{H}(x,y) by performing a two-party protocol. The i-th entry of the vector x is denoted by xᵢεZ_{q}. The entries xᵢ can be represented as binary strings through the following representation:

$${x}_{i} = {\sum }_{j = 0}^{m} {x}_{ij} {2}^{j} .$$

The equality tests are done using variable h.

At the end of the protocol P₁ and P₂ decrypt h. Invariant in this protocol is

$$h = δ {\sum }_{k = 0}^{j} {( {x}_{k} - {y}_{k} )}^{2} .$$

In order to compute d_{H}(x,y), the above defined protocol has to be performed for every entry xᵢ, yᵢ of the vectors x and y. Denote the outcomes for the entry i by hᵢ. Then,

$$[ [ {d}_{H} ( x , y ) ] ] = [ [ {\sum }_{i} {h}_{i} ] ] = {\prod }_{i}^{} [ [ {h}_{i} ] ] .$$

Then both players decrypt together [[d_{H}(x,y)]].

As a sixth application of the conditional gate, computation of the Euclidean distance is shown. The difference with the Hamming distance computation consists in the measure of similarity. For two vectors x and y of length n, the Euclidean distance d_{E}(x,y) is defined as

$${d}_{E} ( x , y ) = {\sum }_{i = 1}^{n} {( {x}_{i} - {y}_{i} )}^{2} .$$

In order to compute d_{E}(x,y) the players perform the following steps:

Player 1 computes [[xᵢ²]] for all i=1, . . . , n from its knowledge of the xᵢ. Similarly player 2 computes [[yᵢ²]] for all i=1, . . . , n.

Both players compute [[oᵢ]]=[[xᵢ²−2xᵢyᵢ+yᵢ²]]. Therefore player I sends [[xᵢ]] to player 2 who can then compute [[2xᵢyᵢ]] (together with a proof that she used the correct yᵢ, i.e. the same one as she used in the computation of yᵢ².) Then they compute [[xᵢ²−2xᵢyᵢ+yᵢ²]].

Finally, they compute [[d_{E}(x,y)]] by making use of the homomorphic properties of the encryption scheme as follows,

$$[ [ {d}_{E} ( x , y ) ] ] = {\prod }_{i = 1}^{n} [ [ {o}_{i} ] ] = [ [ {\sum }_{i = 1}^{n} {o}_{i} ] ] .$$

By using fair threshold decryption, the result is obtained.

Again, the threshold version of this computation is considered, i.e. the case where one (or both) of the players only get the answer to the decision problem d_{E}(x,y)>μ for some threshold μ. In that situation, both players have to use the binary representation of their inputs and compute in binary representation the values of the outcomes [[oᵢ]]. Then, they compute the binary representation of

$${\sum }_{i = 1}^{n}$$

oᵢ by using the same methods as explained before. Then, they carry out the “Millionaires” protocol to obtain the encrypted result. Finally, they use fair threshold decryption to reveal the solution to both players.

As a seventh second application of the conditional gate, another well-known similarity measure for comparing two vectors is shown, the normalized scalar product, which is defined as

$$< x , y >= ( {\sum }_{i = 1}^{n} {x}_{i} {y}_{i} ) / ( ‖ x ‖ ‖ y ‖ ) where ‖ x ‖ = √ ( {\sum }_{i = 1}^{n} {x}_{i}^{2} ) .$$

As the data x,y are private, the numbers 1/∥x∥ and 1/∥y∥ can be computed privately by the respective players. The sum

$$[ [ {\sum }_{i = 1}^{n} {x}_{i} {y}_{i} ] ]$$

can be computed using the homomorphic properties of the El Gamal encryption scheme. Using the homomorphic properties once more, one obtains <x,y>. Finally, the value is obtained by applying (fair) threshold decryption and by extending the technique of P-A. Fouque, J. Stem, G-J. Wackers, “CryptoComputing with rationals”, in Financial Cryptography, 2001, to deal with rational numbers to the El Gamal case.

In order to solve the associated decision problem, i.e. to decide whether <x,y>>μ for some well defined threshold μ all computations have to be done in the binary representation as explained before. Moreover as 0≦μ≦1, it looks favorable to solve the following associated decision problem:

$$( 1 / μ ) {\sum }_{i = 1}^{n} {x}_{i} {y}_{i} \geq ‖ x ‖ ‖ y ‖ .$$

Then the “Millionaires” protocol has to be applied. Finally, the result is obtained by applying (fair) threshold decryption.

In order to illustrate the wide applicability of the invention, an eight application of the conditional gate is shown: secure auctions.

An auction consists of two phases: a bidding phase during which the participants send their bids to the auctioneer, and an opening phase during which the auctioneer announces the highest price and the identity of the winner.

The following model is assumed. There are m bidders, P₁, . . . , Pₘ. The bids are given by x₁=(x_{1,n-1}, . . . , x_{1,0})₂, . . . , xₘ(x_{m,n-1}, . . . , x_{m,0})₂. The representations are ordered from msb to lsb in this notation. The bidders encrypt their bids with the joint public key of the servers, and send those to the auctioneer; [[xᵢ]]=[[x_{i,n-1}]], . . . , [[x_{i,1}]]. There are k servers. The method for highest price auctions will be described.

An algorithm for determining the identity of the highest bidder is presented. This algorithm is used by the servers to determine securely the highest bid and the identity of the highest bidder(s). Here fore, a set of n+1 selection vectors wᵢε{0,1}^{m}, i=−1, . . . , n−1 is defined that keep track of the identities of the highest bidder up to bit i (starting from the msb). The algorithm starts with the vector wₙ₋₁ and the identity of the highest bidder is contained in the vector w₋₁. In order to give the dynamics that updates wᵢ to wᵢ₋₁, a second set of vectors tᵢε{0,1}^{m+1} i=0, . . . , n−1 is defined. The vectors tᵢ check whether the vector xⱼwⱼ equals the zero vector. The j-th component of the vectors wᵢ, tᵢ is denoted by w_{j,i}, t_{j,i}. The initial condition for the t vectors is given by t_{0,j}=0 for j=0, . . . , n−1 and for the w-vectors is given by wₙ₋₁=(1, . . . , 1). The polynomials are defined by F(s,z)=s+(1−s)z and Gₐ(s,z)=s(z+(1−z)(1−a)). The dynamics is then defined by the following updating rule: t_{j,i}=F(t_{j-1,i}, x_{j,i}w_{j,i}), t_{m,i}=F( . . . F(F(t₀ᵢ,x₁ᵢw₁ᵢ),x₂ᵢw₂ᵢ) . . . ), and w_{j,i-1}=Gₜ_{_{m,i}}(w_{j,i}, x_{j,i}), for i=n−1, . . . , 0 starting with i=n−1 and for each i, the counter j runs from 1 to m. Note that tₘᵢ=1 means that at least one of the components of the vector xⱼwⱼ equals one. In order to compute the vector w₋₁ securely, the servers use the generalized millionaires protocol based on the conditional gate.

When the vector w₋₁ has been computed securely, the servers use fair threshold decryption to decrypt the entries of the vector w₋₁. The identities of the winning bidders correspond to the positions of the entries of w₋₁ that are equal to one. Using this identifier, they can find the corresponding highest bid and use threshold decryption to decrypt it.

This protocol satisfies the same advantages as formulated by Juels and Jakobsson in US patent aforementioned, in particular it satisfies: non interactivity, auction adaptability, full privacy, robustness, multiple servers and public verifiability, while it avoids the relatively computationally expensive Mix computation.

This protocol can be extended to Vickrey (second-price) auctions. A Vickrey auction is an auction where the highest bidder wins but the clearing price, i.e. the price that the winner has to pay, is equal to the second highest bid. In order to perform a Vickrey auction, the following approach is possible. First the servers determine the identities of the winners (but not the winning bids) with the protocol given above. Then, they remove the winners and their bids from the list. Finally, they evaluate the following set of polynomials, pⱼ=F( . . . F(F(0,x_{1,j}w_{1,j}),x_{m,j}w_{m,j}), for j=n−1, . . . , 0 and where F is as defined above. The vector p=(pₙ₋₁, . . . , p₀) contains then the maximum bid price.

Finally, two applications using the private-multiplier multiplication protocol are shown. The first application is the generalized millionaires problem.

In the millionaires problem, the respective inputs x and y are both private to the players. In many applications (e.g. secure profile matching), however, one or both of the inputs will be shared. If only one input is shared, say x, the multiplication can still be used with a private multiplier protocol at a few steps in the algorithms. For the millionaires algorithm this leads to 2n private multiplier protocols and n dichotomous multiplication protocols. If both inputs are shared however, it is necessary to use the dichotomous multiplication protocol at all steps, giving 3n uses of the dichotomous multiplication protocols.

If one input is shared say x, and the other input is a known constant T, the following protocol is possible. Replace yⱼ with Tⱼ for j=0, . . . , n−1 and compute {[[xⱼ−Tⱼ]]} for j=0 . . . n−1 by using the homomorphic properties of the encryption scheme. In this way the problem is transformed into the inequality x−T>0. Then, only the computation of [[v(xⱼ−Tⱼ)]] has to be done with the dichotomous multiplication protocol (leading to n dichotomous multiplications).

As a second application, secure profile matching is shown.

In recent years, the availability to users of large amounts of content (audio, video, text, etc) in electronic form has called for the development of methods for information selection. Such methods are most commonly based on the idea of personalization, where information is selected for a given user according to the profile of preferences of that user. Such systems are generally known as recommended systems.

Collaborative filtering techniques are recommended systems in which the recommendation of content is based on the similarity between the profile of a given user and the profiles of other users (and not in the features of the content itself). If the measure of similarity between any two profiles is high enough (according to some pre-defined criterion), the system can recommend to one user the highly appreciated content items of the other user, which have not yet been seen by that first user.

Here this setting is extended to the ad-hoc case where two users can compare their profiles and find out whether they have a similar taste. If so, they might start a procedure to exchange content with each other. If not, the protocol guarantees that no other private information is leaked than the fact that the profiles are not similar.

By private comparison of two profiles, it is meant that the users compute securely a beforehand agreed test function. In a second phase they compare this (encrypted) value securely with a threshold; i.e. at the end of the protocol, the only knowledge the players get is whether the value of the test function exceeds the threshold or not.

The participants are assumed to have an authenticated channel with each other. For sake of clarity this description is restricted to the case where the private profiles of the users consist of binary vectors denoted as x and y but extensions to non-binary vectors are also possible.

A first measure for comparing two vectors is given by the number of entries in which they differ. This measure can be defined in terms of the Hamming distance d_{H}(x,y) between two vectors x,yε{0,1}ⁿ which is given by

$${d}_{H} ( x , y ) = {\sum }_{i = 1}^{n} δ ( {x}_{i} - {y}_{i} ) ,$$

where δ(x)=0 if x=0 and δ(x)=1 if x≠0. The second measure considered will be the scalar product defined as

$${d}_{S} ( x , y ) = {\sum }_{i = 1}^{n} {x}_{i} {y}_{i} .$$

The goal of this section is to show how d_{H}(x,y) and d_{S}(x,y) can be computed and compared to a threshold in a private way.

The private computation of d_{H}(x,y) can be performed by running the private multiplier multiplication protocol and using threshold decryption to decrypt the result. The private computation of d_{S}(x,y) is also based on the private multiplier multiplication protocol and the homomorphic properties of the ElGamal crypto system.

A more interesting situation arises when the decision problem d_{H}(x,y)>μ or d_{S}(x,y)>μ for a threshold μ chosen by one or both of the players has to be solved in a private way. It is assumed that μ is given in its binary representation μₙ₋₁, . . . , μ₀. The next protocol solves the decision problem for d_{H}(x,y), whereas the situation for d_{S}(x,y) is completely analogous and the details are therefore omitted:

First, the players set up a threshold ElGamal system using a key generation protocol.

For each component i=1, . . . , n both players compute securely [[oᵢ]]=[[δ(xᵢ−yᵢ)]] using the “socialist” protocol of the section on the Millionaires problem or by computing [[oᵢ]]=[[(xᵢ−yᵢ)²]] using the private multiplier multiplication protocol.

They compute privately the bit-representation of

$$[ [ s ] ] = [ [ {\sum }_{i = 1}^{n} {o}_{i} ] ] .$$

As a result the players obtain ([[sₙ₋₁]], . . . , [[s₀]])₂; the binary representation of

$$[ [ {\sum }_{i = 1}^{n} {o}_{i} ] ] .$$

The players carry out the millionaires protocol on [[s]] and [[μ]] to check whether [[s]]≧[[μ]].

Finally, they apply (fair) threshold decryption to decrypt the result of the decision problem.

This protocol requires O(n log n) exponentiations per player.

The previous approach can be extended to the case where the entries belong to a discrete (bit not binary) domain. The idea is the same but the computations require more steps and details. It is emphasized that also in that case, full privacy can guaranteed.

FIG. 2 Illustrates the device and computer program product for implementing the method according to the invention.

The device 200 comprises a memory 201, processing means 202, input means 203, and output means 204, being arranged to implement the method according to the invention.

A computer program product 210 may carry instructions that, when loaded, cause a programmable device in device 200 to execute the steps necessary to implement the method according to the invention.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. A single processor or other (programmable) unit may also fulfill the functions of several means recited in the claims.

In the device claim enumerating several means, several of these means can be embodied by one and the same item of hardware. The mere fact that certain measures are recited in mutually different dependent claims does not indicate that a combination of these measures cannot be used to advantage.

1. A method for a party participating in a secure multiparty multiplication protocol between participants, the protocol being arranged to compute the product of private first data and encrypted second data, wherein the protocol comprises a subprotocol comprising the steps of
the party (100) obtaining first data (101), which is either
private first data or
first data from a two-valued domain,
the party obtaining encrypted second data (102),
the party computing encrypted output data (103) which comprises a randomized encryption of the product of the first data and the second data, using a discrete log based cryptosystem, and
the party generating a proof (104) being arranged to show that the encrypted output data is correct.

2. Method according to claim 1, wherein the first data is random data from a two-valued domain.

3. Method according to claim 1, wherein the discrete log based cryptosystem is the ElGamal cryptosystem.

4. The method according to claim 1, wherein the encrypted data are Pederson commitments.

5. The method according to claim 1, wherein the protocol further comprises the further step of the party transmitting the proof to at least one of the other participants.

6. The method according to claim 1, wherein the protocol comprises the further step of the party transmitting the encrypted output data to at least one of the other participants.

7. The method according to claim 1, wherein the protocol is executed between two parties.

8. A device (200) being arranged for implementing the method according to claim 1.

9. A computer program product (210), for enabling multiparty computations, having computer executable instructions for causing a programmable device to perform the method according to claim 1.
